(19) United States
(12) Patent Application Publication
(10) Pub. No.: US 2013/0097183 A1
(43) Pub. Date: Apr. 18, 2013

(54) METHOD AND APPARATUS FOR ANALYZING A ROOT CAUSE OF A SERVICE IMPACT IN A VIRTUALIZED ENVIRONMENT

(71) Applicant: Zenoss, Inc., Annapolis, MD (US)

(72) Inventor: Ian C. McCracken, Austin, TX (US)

(73) Assignee: ZENOSS, INC., Annapolis, MD (US)

(21) Appl. No.: 13/646,978

(22) Filed: Oct. 8, 2012

Related U.S. Application Data
(63) Continuation-in-part of application No. 13/396,702, filed on Feb. 15, 2012.
(60) Provisional application No. 61/547,153, filed on Oct. 14, 2011.

(51) Int. Cl. G06F 17/30

(52) U.S. Cl. 707/748; 707/E17.011

(57) ABSTRACT

A dependency graph includes nodes representing states of infrastructure elements in a managed system, and impacts and events among the infrastructure elements in a managed system that are related to delivery of a service by the managed system. Events are received that cause change among the states in the dependency graph. An event occurs in relation to one of the infrastructure elements of the dependency graph. Each individual node that was affected by the event is analyzed and ranked based on (i) states of the nodes which impact the individual node, and (ii) the states of the nodes which are impacted by the individual node, to provide a score for event(s) which is associated with the individual node. Plural events are ranked based on the scores. The root cause of the events with respect to the service is provided based on the events which were ranked.

### CROSS-REFERENCE TO RELATED APPLICATIONS

This application is a continuation-in-part and claims priority to U.S. Ser. No. 13/396,702 filed 15 Feb. 2012 which claims the benefit of provisional application 61/443,848 filed 17 Feb. 2011, and this application claims the benefit of provisional applications 61/547,153 filed 14 Oct. 2011, all of which are expressly incorporated herein by reference.

### TECHNICAL FIELD

The technical field in general relates to data center management operations, and more specifically to analyzing events in a data center.

### BACKGROUND

Complex data center environments contain a large number of infrastructure elements which interact to deliver services such as email, e-commerce, web, and a wide variety of enterprise applications. Failure of any component in the data center may or may not have an impact on service availability, capacity, or performance. Static mapping of infrastructure and application components to services is a well understood process, however the introduction of dynamic virtualized systems and cloud computing environments has created an environment where these mappings can change rapidly at any time.

Traditional systems such as EMC SMARTS or IBM NetCool have been designed to address Impact Analysis for services deployed in traditional fixed infrastructure data centers. In this environment dependencies are well known when policies are defined, and as such it is possible to define event patterns or “fingerprints” which have some impact on service availability, capacity, or performance.

The nature of dynamic data center environments facilitates rapid deployment of virtualized infrastructure or automated migration of virtual machines in response to fluctuating demand for application services. As a result traditional Impact Analysis and Service Assurance engines based on infrastructure “fingerprinting” break due to the fact that policies are not dynamically updated as service dependencies change.

In a dynamic virtualized datacenter, any number of problems may affect any given component in the datacenter infrastructure; these problems may in turn affect other components. By a creating a dynamic dependency graph of these components and allowing a component's change in state to propagate through the graph, the number of events one must manually evaluate can reduced to those that actually affect a given node, by examining the events that have reached it during propagation; this does not, however, minimize the number of events to a single cause, because any event may be a problem in itself or may indicate merely a reliance on another component with a problem. Although fewer events must be examined to solve a given service outage, it still might take an operator several minutes to determine the actual outage-causing event.

When an event storm occurs, and the dependency graph propagation invention filters down the events of what errors are occurring, there will still be 2, 10-15, or 100 or more events (as examples) after working through the storm. There is a need for an operator at the console to be able to easily figure out which of the events is the actual cause of the event storm, because one event is probably the cause of the other events.

The other available systems depend on a priori knowledge of the types of events. If there is an event that a server is non-responsive, these systems require prior knowledge that this event is more important than that a machine is non-responsive. Typical root cause analysis methods are unable to react to changes in the dependency topology, and thus must be more detailed; since they require extensive a priori knowledge of both the nodes being monitored, the relationships between the nodes being monitored and the importance of the types of events that may be encountered, they are extremely prone to inaccuracy without constant and costly reevaluation. Furthermore, they are inflexible in the face of event storms or the migration of virtual network components, due to their reliance on a static configuration.

Therefore, to address the above described problems and other problems, what is needed is a method and apparatus that analyzes a root cause of a service impact in a virtualized environment.

### SUMMARY OF THE INVENTION

Accordingly, one or more embodiments of the present invention provide a computer implemented system, method and/or computer readable medium that determines a root cause of a service impact.

An embodiment provides a dependency graph data storage configured to store a dependency graph that includes nodes which represent states of infrastructure elements in a managed system, and impacts and events among the infrastructure elements in a managed system that are related to delivery of a service by the managed system. Also provided is a processor. The processor is configured to receive events that can cause change among the states in the dependency graph, wherein an event occurs in relation to one of the infrastructure elements in a managed system. For each of the events, an analyzer is executed that analyzes and ranks each individual node in the dependency graph that was affected by the event based on (i) states of the nodes which impact the individual node, and (ii) the states of the nodes which are impacted by the individual node, to provide a score for each of at least one event which is associated with the individual node; a plurality of, or alternatively, all of, the events are ranked based on the scores; and the rank can be provided as indicating a root cause of the events with respect to the service.

In another embodiment, the dependency graph represents relationships among all infrastructure elements in the managed system that are related to delivery of the service by the managed system, and how the infrastructure elements interact with each other in a delivery of said service, and a state of an infrastructure element is impacted only by states among its immediately dependent infrastructure elements of the dependency tree. The state of the service can be determined by checking current states of infrastructure elements in the dependency tree that immediately depend from the service.

In yet another embodiment, the individual node in the dependency graph is ranked consistent with the formula (ra/n+1)+w, to provide the score for each of the at least one event which is associated with the individual node, wherein:

r=an integer value of the state caused by the at least one event;

a=an average of the integer values of the states of nodes impacted, directly or indirectly, by the node affected by the at least one event;

n=number of nodes with states affected by other events impacting the node affected by the at least one event; and

w=an optional adjustment that can be provided to influence the score for the at least one event.

In yet another embodiment, the states indicated for the infrastructure element include availability states of at least: up, down, at risk, and degraded, “up” indicates a normally functional state, “down” indicates a non-functional state, “at risk” indicates a state at risk for being “down”, and “degraded” indicates a state which is available and not fully functional.

In still another embodiment, states indicated for the infrastructure element include performance states of at least up, degraded, and down, “up” indicates a normally functional state, “down” indicates a non-functional state, and “degraded” indicates a state which is available and not fully functional.

In another embodiment, the infrastructure elements include: the service; a physical element that generates an event caused by a pre-defined physical change in the physical element; a logical element that generates an event when it has a pre-defined characteristic as measured through a synthetic transaction; a virtual element that generates an event when a predefined condition occurs; and a reference element that is a pre-defined collection of other different elements among the same dependency tree, for which a single policy is defined for handling an event that occurs within the reference element.

In still another embodiment, the state of the infrastructure element is determined according an absolute calculation specified in a policy assigned to the infrastructure element.

Further, the purpose of the foregoing abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The abstract is neither intended to define the invention of the application, which is measured by the claims, nor is it intended to be limiting as to the scope of the invention in any way.

### BRIEF DESCRIPTION OF THE DRAWINGS

The accompanying figures, where like reference numerals refer to identical or functionally similar elements and which together with the detailed description below are incorporated in and form part of the specification, serve to further illustrate various exemplary embodiments and to explain various principles and advantages in accordance with the present invention.

FIG. 1A and FIG. 1B are an Activity Diagram illustrating an example implementation of an analysis of a Root Cause.

FIG. 2 is an example dependency graph.

FIG. 3 is a flow chart illustrating a procedure for event correlation related to service impact analysis.

FIG. 4 is a relational block diagram illustrating a structure to contain and analyze element and service state.

FIG. 5 and FIG. 6 illustrate a computer of a type suitable for implementing and/or assisting in the implementation of the processes described herein.

FIG. 7A to FIG. 7B are a screen shot of a dependency tree.

FIG. 8 is a block diagram illustration portions of a computer system.

### DETAILED DESCRIPTION

In overview, the present disclosure concerns data centers, typically incorporating networks running an Internet Protocol suite, incorporating routers and switches that transport traffic between servers and to the outside world, and may include redundancy of the network. Some of the servers at the data center can be running services needed by users of the data center such as e-mail servers, proxy servers, DNS servers, and the like, and some data centers can include, for example, network security devices such as firewalls, VPN gateways, intrusion detection systems and other monitoring devices, and potential failsafe backup devices. Virtualized services and the supporting hardware and intermediate nodes in a data center can be represented in a dependency graph in which details and/or the location of hardware is abstracted from users. More particularly, various inventive concepts and principles are embodied in systems, devices, and methods therein for supporting a virtualized data center environment.

The instant disclosure is provided to further explain in an enabling fashion the best modes of performing one or more embodiments of the present invention. The disclosure is further offered to enhance an understanding and appreciation for the inventive principles and advantages thereof, rather than to limit in any manner the invention. The invention is defined solely by the appended claims including any amendments made during the pendency of this application and all equivalents of those claims as issued.

It is further understood that the use of relational terms such as first and second, and the like, if any, are used solely to distinguish one from another entity, item, or action without necessarily requiring or implying any actual such relationship or order between such entities, items or actions. It is noted that some embodiments may include a plurality of processes or steps, which can be performed in any order, unless expressly and necessarily limited to a particular order; i.e., processes or steps that are not so limited may be performed in any order.

Much of the inventive functionality and many of the inventive principles when implemented, are best supported with or in software or integrated circuits (ICs), such as a digital signal processor and software therefore, and/or application specific ICs. It is expected that one of ordinary skill, notwithstanding possibly significant effort and many design choices motivated by, for example, available time, current technology, and economic considerations, when guided by the concepts and principles disclosed herein will be readily capable of generating such software instructions or ICs with minimal experimentation. Therefore, in the interest of brevity and minimization of any risk of obscuring the principles and concepts according to the present invention, further discussion of such software and ICs, if any, will be limited to the essentials with respect to the principles and concepts used by the exemplary embodiments.

### DEFINITIONS

The claims may use the following terms which are defined to have the following meanings for the purpose of the claims herein. However, other definitions may be provided elsewhere in this document.

“State” is defined herein as having a unique ID (that is, unique among states), a descriptor describing the state, and a priority relative to other states.

“Implied state” is the state of the infrastructure element which is calculated from its dependent infrastructure elements, as distinguished from a state which is calculated from an event that directly is detected by the infrastructure element and not through its dependent infrastructure element(s).

“Current state” is the state currently indicated by the infrastructure element.

“Absolute state” of the infrastructure element begins with the implied state of the infrastructure element (which is calculated from its dependent infrastructure elements), but the implied state is modified by any rules that the infrastructure element is attached to. The absolute state of an infrastructure element may be unchanged from the implied state if the rule does not result in a modification.

“Infrastructure element” is defined herein to mean a top level service, a physical element, a reference element, a virtual element, or a logical element, which is represented in the dependency graph as a separate element (data structure) with a unique ID (that is, unique among the elements in the dependency graph), is indicated as being in a state, has a parent ID and a child ID (which can be empty), and can be associated with rule(s).

“State change” is defined herein to mean a change from one state to a different state for one element, as initiated by an event; an event causes a state change for an element if and only if the element defines the event to cause the element to switch from its current state to a different state when the event is detected; the element is in only one state at a time; the state it is in at any given time is called the “current state”; the element can change from one state to another when initiated by an event, and the steps (if any) taken during the change are referred to as a “transition.” An element can include the list of possible states it can transition to from each state and the event that triggers each transition from each state.

A “rule” is defined herein as being evaluated based on a collective state of all of the immediate children of the element to which the rule is attached.

“Synthetic transaction” or “synthetic test” means a benchmark test which is run to assess the performance of an object, usually being a standard test or trial to measure the physical performance of the object being tested or to validate the correctness of software, using any of various known techniques. The term “synthetic” is used to signify that the measurement which is the result of the test is not ordinarily provided by the object being measured. Known techniques can be used to create a synthetic transaction, such as measuring a response time using a system call.

<End of Definitions>

As further discussed herein below, various inventive principles and combinations thereof are advantageously employed to analyze a root cause of a service impact in a virtualized environment.

Services and their dependency chain(s) such as those discussed above can readily be defined in a dependency tree using a tree representing all of the physical elements related to the delivery of the service itself. This dependency tree can be a graph showing the relationships of physical elements and how they interact with each other in the delivery of a given service (hereafter, “dependency graph”). A dependency graph can be constructed, which breaks down so that the state of a given piece of infrastructure is impacted only by its immediate dependencies. At the top level service, we do not care about the disk drive at the end of the chain, but instead only upon certain applications that immediately comprise the top level service; those applications are dependent on their servers on which they run; and their servers are dependent upon their respective drives and devices to which they are directly connected. If a state of a drive changes, e.g., it goes down, then the state of the drive as it affects its immediate parents is determined; as we roll up the dependency graph that change may (or may not) propagate to its parents; and so on up the dependency graph if the state change affects its parents. An example of one type of a dependency graph is discussed further at the end of this document.

The method and/or system can use the state and configuration provided by a dependency graph to rank the events affecting a given node by the likelihood that they have caused the node's current state, allowing an operator tasked with the health of that node simply to work his way down the list of events. This potentially reduces the time from failure to resolution to only a minute or two.

This system and method can provide a way of determining which of those events is the most important just by knowing where the event occurred, without knowing a priori the relative importance of the events.

This can be used in connection with small scale systems (e.g., a single computer), used with cloud computing, and/or used with a massive environment with many thousands of devices and virtual machines and hundreds and thousands of components interfaces and, e.g., a SAM (security accounts manager database) on top of that. The purposes is that when a component, e.g., a SAM, goes bad on one host, some or all of the machines and OS's and services that are layered on top of that will go bad thereby creating an event storm. However, this method and system can narrow it down to the root cause—in this example the SAM going down—or whatever triggered the event storm.

The conventional systems cannot reasonably narrow down to the root cause because the events have been prioritized relative to each other event before the events occur. The reason this is insufficient, is that the conventional system must first know everything that can happen and then can rank events according to how important they are. This is not flexible since it must be changed if the relative structure changes.

The conventional methodology is also not always accurate since an event in one case may be very important but irrelevant in another. For example, consider that a disk goes down. In this example, there are three machines that all run databases in a database cluster—losing even two of the three machines still allows the database cluster to run. However, if the machine with the only web server goes down, the database cluster is OK but the web server is not. The layers down to an event of “disk died” would be reported, but in a conventional system the event that the “disk died” would not be indicated as more important than “host down”, “web server down”, “OS down”, which will also have occurred. In a conventional system, these events would be ranked in a pre-determined order such as ping-down events, or perhaps chronologically. Conventionally, events occur at different times.

The method and/or system disclosed herein can rank or score these events and indicate that the “disk died” event is the most probable cause of the error. Optionally the other events can be reported as well.

Consider an example, where the disk goes down, so that the box goes down, so that the web server goes down. If one box goes down, perhaps a hundred virtual machines go down. It is really hard to sift through the information to determine what the root problem is. The conventional system which uses chronology for listing events would likely note the disk down as the first event solely because it was the first event that was detected. If the disk was not noted first, e.g., host down event is noted first because the device event was late (e.g., time out), then the disk down might even be listed as the last event and might be interpreted as the least relevant event. Because these systems are virtualized, if one physical box goes down than many things go down which depend on the box. It is really difficult to determine what the root problem really is.

The system or method discussed herein uses information provided by the dependency graph. The discussion assumes familiarity with dependency graphs, and for example a dynamic dependency graph commercially available from Zenoss, Inc. Some discussion thereof is provided later in this document.

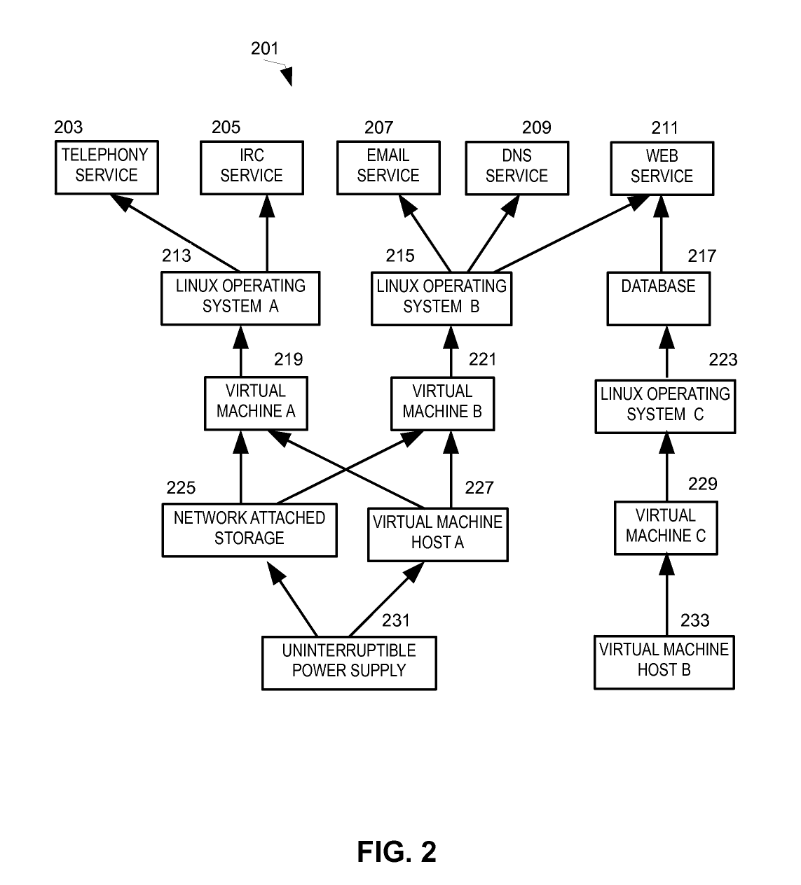

Referring now to FIG. 2, an example dependency graph 201 will be discussed by way of overview. The general idea of a dependency graph 201 is that a representation of an entire computing environment can be organized into the dependency graph. Such a dependency graph will indicate, e.g., the host dependent on the disk, and the servers dependent on the host, etc. If a disk goes down, the state changes caused by the event get propagated up the dependency graph to the top (e.g., up to the services 203-211), notifications are issued, and the like. At any point in the graph, e.g., the database cluster, can be configured with a “gate” (policy) so that the state change will not propagate any further up the graph. Thus, when the virtual environment changes, the dependency graph 201 does not need to be reconfigured. Further discussion of FIG. 2 is provided below.

The system and method discussed herein can also work with a simple dependency graph. The present embodiment accounts for the potential reconfigurations (aka policies) anywhere in the graph. A policy defines when a node is up (e.g., when any one of its lower nodes is up) If there is a problem on the database cluster box and another box, the other box is going to be considered more important because the database cluster. The intervening states caused by those events, including policy, are taken into account. This causes one of two otherwise equally important events to be indicated as more important. Any reconfiguration of the dependency graph is taken into account in the present system and method, because it looks at all of the nodes in between the present node and its respective top and bottom. Because the way the algorithm works is to look at all of the nodes between the current node and its topmost node.

The method and/or system improves upon other root cause determination methods by virtue of its flexibility in dealing with a dynamic environment: it can analyze the paths by which state changes have propagated through the dependency graph, requiring no a priori knowledge of the nodes or events themselves, to calculate a score that can represent the confidence that the event caused the node's status to change. Due to the method's efficiency, the confidence score can be calculated upon request, and/or can be provided real time and/or can be provided continuously. This allows the same event to be treated as more or less important over time given the instant state of the dependency graph and the introduction of new events. Finally, because the method requires no state beyond that reflected in the dependency graph, it can be executed in any context independently. This allows contextual configurations to be taken into account; for example, a node may be critical in the case of one datacenter service (email, DNS, etc.) while irrelevant in another. Thus, the same event may be considered unimportant in one context, while causative in another, based on the configuration of the dependency graph.

Within a context, the method can calculate a score for each event, taking into account several factors, including the state caused by the event, the states of the nodes impacted by the node affected by the event, and the number of nodes with other events impacting the node affected by the event. In addition, an allowance is made for adjustment based on one or more postprocessing plugins. The events are then ranked by that score, and the event that is likeliest to be the cause rises to the top.

A directed dependency graph may be created from an inventory of datacenter components merely by identifying the natural impact relationships inherent in the infrastructure—for example, a virtual machine host may be said to impact the virtual machines running on it; each virtual machine may be said to impact its guest operating system; and so on. The nodes (components) and edges (directed impact relationships) may be stored in a standard graph schema in a traditional relational database, or simply in a graph database.

Each node may be considered to have a state (up, down, degraded, etc.). As events are received that may be considered to affect the state of a node, the new state of the node should be stored in the graph database and a reference to the event stored with the node. This allows one to later traverse the graph to determine all events that may affect the state of a node.

Any state change should then follow impact relationships, and the state of the impacted node updated to reflect a new state with respect to the state of the impacting node. Each node may be configured to respond differently to the states of its impacting nodes; for instance, a node may be configured to be considered “down” only if all the nodes impacting it are also “down,” “degraded” if any but not all nodes are “down,” “at risk” if one of its redundant child nodes are “down”, and “up” if all of its impacting nodes are “up.”

For example, still referring to FIG. 2, in an example dependency graph 201, an event causing the node “Virtual Machine C” 229 to be considered “down” would likewise cause “Linux operating system C” 223, “Database” 217 and “Web service” 211 to be considered down, unless a policy were configured on “Web service” 211 so that it would be considered “down” only if both “Linux operating system C” 223 and “Linux operating system B” 215 were down.

An event bringing down “Virtual Machine Host A” 227 would cause every top-level service 203-211 to be “down.” If one of the virtual machine hosts 227, 233 is down, all the virtual machines 219, 221, 229 running on the virtual machine host(s) would be down as well, and events related to them would eventually be detected as well, causing their states to be marked “down” in their own right. The same is true of the operating systems 213, 215, 223 and services 203-211 running on each of those operating systems. Thus, in one example, the number of events potentially causing “Telephony service” 203 to be down, with no ranking applied, would be four: the event notifying that the host 227 is down, the event notifying that the virtual machine 219 is off, the event notifying that the operating system 213 is unreachable, and the event notifying that the service 203 itself is no longer running. It is this situation in which the root cause method or system comes into play.

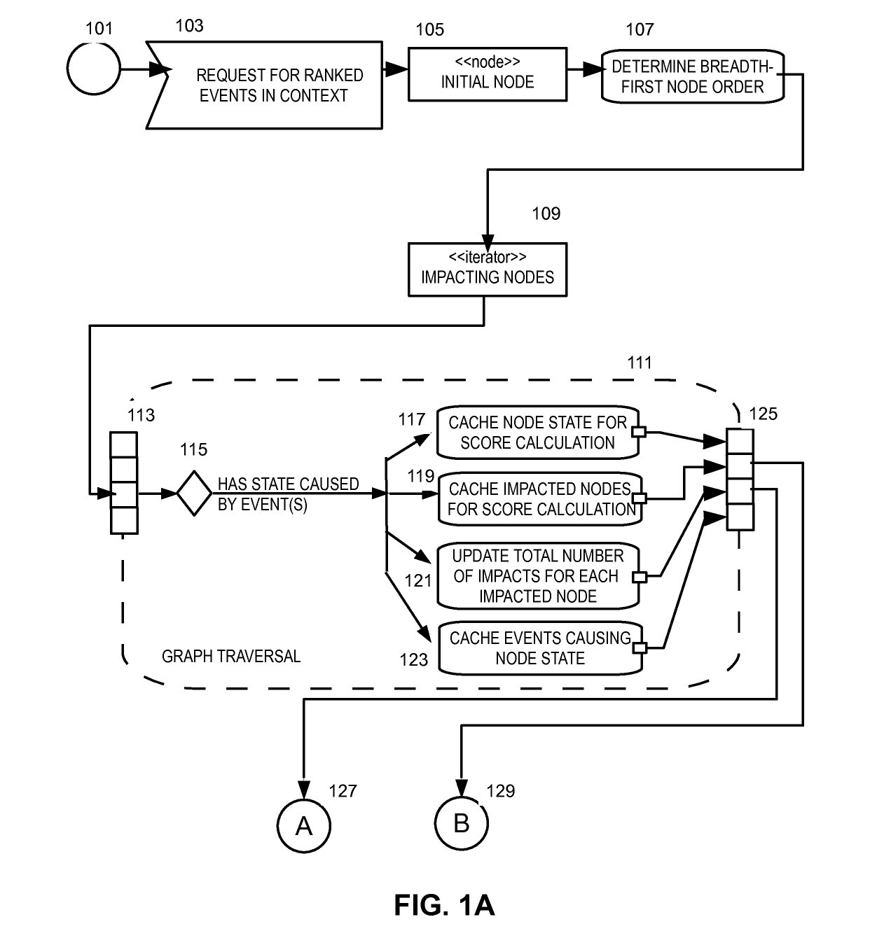

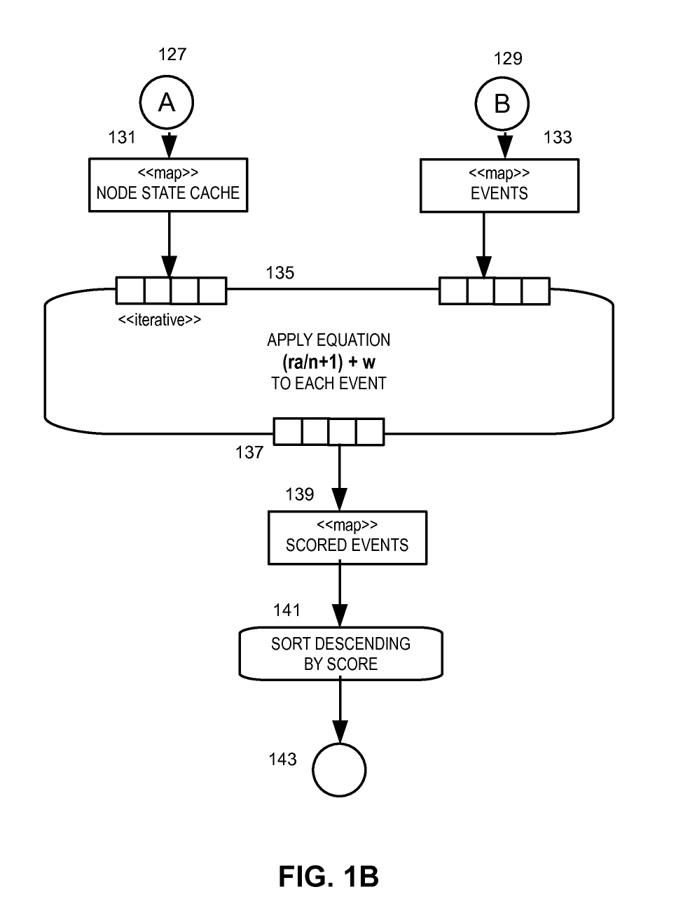

Referring now to FIG. 1A and FIG. 1B, an Activity Diagram illustrating an example implementation of an analysis 101 of a Root Cause will be discussed and described. When a list of events ranked by probability of root cause is requested 103 for a given node, all events potentially affecting the state of the node may be determined and a score for each calculated, based on the state of the dependency graph at that time.

A score for each event can be calculated 135 using the following equation:

$$\frac{ra}{n + 1} + w \qquad ( 1 )$$

Where:

r=The integer value of the state caused by the event;

a=The average of the integer values of the states of nodes impacted, directly or indirectly, by the node affected by the event;

n=The number of nodes with states affected by other events impacting the node affected by the event; and

w=An adjustment that can be provided by one or more postprocessors to influence an event's score. Adjustment w can be omitted.

In overview, the method or system traverses the dependency graph, e.g., it can execute a single breadth-first traversal 107-125 of the dependency graph starting at the service node 105 in question from impacted node to impacting node 109, accumulating relevant data. When the traversal 111 is complete, r, a and n are determined 135 for each event affecting a node in the service topology, and a score calculated; these are then adjusted by any postprocessing plugins (which provide w) 135. The final results 139 can be sorted 143 by score. Elements 127 and 129 are connectors to the flow between FIG. 1A and FIG. 1B. This is now described in more detail.

The analysis 101 of the root cause can receive a request 103 for ranked events in context, as one example of a request to determine the root cause of a service impact in a virtualized environment. The request 103 can include an indication of the node in a dependency graph, which has a state for which a root cause is desired to be determined. For example, the e-mail service can be a node (e.g., FIG. 2, 207) for which the root cause is requested; in this example the e-mail service might be non-working. The requested node in the request 103 is treated as an initial node 105.

Then the analysis can determine 107 a breadth-first node order with the initial node at the root. A breadth-first node order traversal or similar can be performed to determine all of the impacting nodes 113 among the dependency graph, that is, the nodes in the dependency graph which are candidates to directly or indirectly impact a state of the initial node. For each of the impacting nodes 113, the analysis can determine 115 whether the impacting node has a state which was caused by one or more events. In this situation, with respect to the impacting node, the node state is cached 117 in a node state cache 131 for later score calculation, the nodes which are impacted by the node state are cached 119 for later score calculation, the total number of impacts for each impacted node are updated 121, and the events causing the node state are cached 123 in an event cache 133.

The impacting nodes 125, the node state cache 131, and the event cache 133 are passed on for a determination of the score for each event, for example using the above equation (1). Then, the analysis can provide a map of scored events 139. The scored events 141 can be sorted by score, so that the events are presented in order of likelihood that the event caused the state of the requested node.

In equation (1), the value represented by a is used due to the possibility of any intervening node being configured in such a way that it is considered unaffected by one or more impacting nodes. Thus, an event that causes a node to be in the most severe state may be relatively unimportant to a node further up the dependency chain. This becomes even more relevant in the case of multiple service contexts, where a node may be configured to treat impacting events as important in the context of one service, but to ignore them in another.

The value represented by n is used because the likelihood that an event on a node is the efficient cause of the state change diminishes significantly in the presence of an impacting node with events of its own. For example, a virtual machine running on a host may not be able to be contacted, and thus may be considered in a critical state; if the host is also unable to be contacted, however, the virtual machine's state is more likely caused by the host's state than it is a discrete event.

The example of FIG. 2 illustrates that the services 203-211 are at the top, and at the bottom are things that might go wrong. The elements below the services just get sucked in by the services, for example, the web service 211 is supported by the database infrastructure 217, which is supported by the Linux operating system 223 and then supported by the Virtual Machine C 229, etc. The elements at the second level (that is, below the top level services 203-211) on down are automatically or manually set up by the dependency graph.

In FIG. 2, there are some redundancies. There are two virtual machines 219, 221 running two different operating systems 213, 215. If Virtual Machine Host B 233 goes down, the web service 211 goes down because of the indirect dependencies. If the UPS 231 then goes down, the web service 211 will still be down, but the two events will be ranked the same because they are both equally affecting the web service 211.

In the case that the UPS 231 goes down, it is also going to take down the network 225 and the Virtual Machine host A 227, virtual machines A and B 219, 221, etc.—everything on the left side of FIG. 2. The method discussed herein analyzes the dependency graph 201 and provides a decision as to which event is most likely the root problem based on where the node with the event sits in the graph.

Compare this to what happens using conventional analysis techniques when the UPS 231 goes down. In a conventional system, the UPS 231 would be predetermined to be more important than the Virtual Machine Host A, etc.—the relative priorities are pre-determined. Because the virtual machines can be moved between hosts, all of the dependencies would have to be recalculated when the virtual machines are changed around. Figuring out these rules is prohibitively complex, because there are so many different things, and they change so frequently.

One or more of the present embodiments, however, can take into account the configuration that says that virtual machine B is not important (gated) to, e.g., the web service.

Setting up the dependency graph is covered in U.S. Ser. No. 13/396,702 filed 15 Feb. 2012 and its provisional application. The dependency graph is an example of possible input to one or more of the present embodiments.

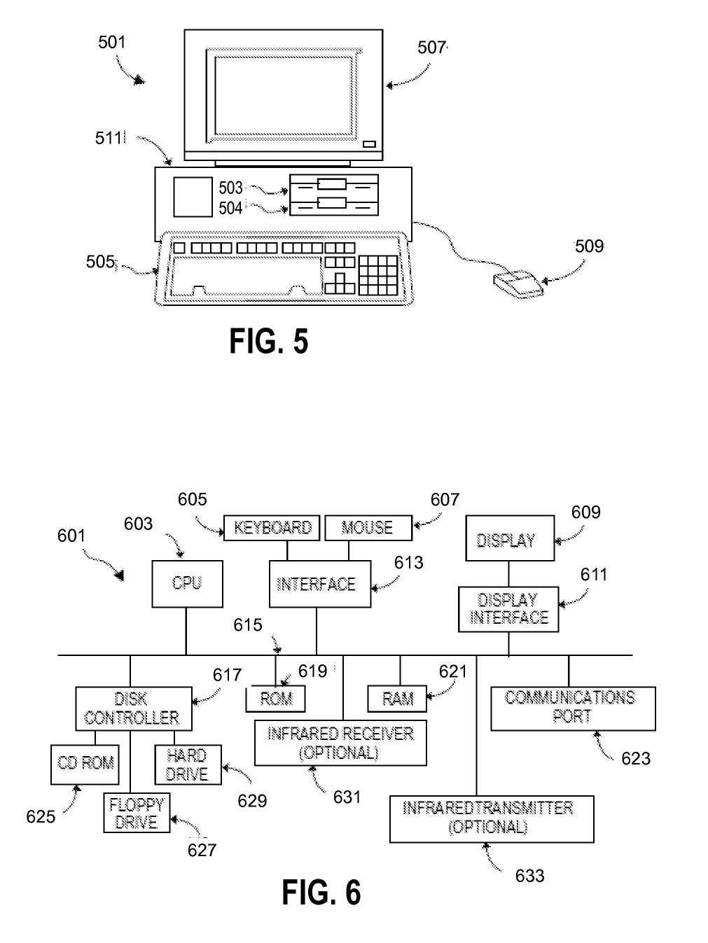

Reference is made back to FIG. 1A and FIG. 1B, a “Root Cause Algorithm—Activity Diagram”. The procedure can advantageously be implemented on, for example, a processor of a computer system, described in connection with FIG. 5 and FIG. 6 or other apparatus appropriately arranged.

Consider an example in which a request 103 from a User Interface is received with a request to list all of the events, further specified by service affected or hardware affected, ranked in order of important for the service or hardware. The method or system discussed herein first finds the initial node of interest 105 that is associated with the service or hardware listed in the request. In this case, the method walks all of the nodes, e.g., in a breadth-first node order 107 which will eventually visit each of the nodes. Other graph traversals can be used instead of breadth-first node order graph traversal 111, although they may be slower. As the method walks the nodes, it gathers the relevant data 117, 119, 121, 123 which includes events on each node. The method will obtain the state that the event caused 117, and store the event(s) 123 for each node. The nodes 119 and their events can be cached, for each of the nodes. In summary, as an initial process, the nodes can be walked to find all of the events on each of the nodes.

Then, the importance of each state that was caused by the event for each node is determined 135. In this example, a calculation to determine the importance of each state can be applied consistent with the equation: (ra/n+1)+w).

In this equation, r is the integer value of each state that was caused by the event, where e.g. r=0 to 3 (e.g., representing the state such as down, up, asleep, waiting, etc.) Importance can be based merely on the state. This represents obtaining the value of each of the “impacted nodes” which were affected by the event in question.

In this equation, a is the average of the states of the nodes impacted by the nodes affected by this event. I.e., for all of the nodes from node under consideration, up to the top of the dependency graph, this is the average all of their states. This is where the policy is taken into account. If the states up above the present node are OK, then probably some policy intervened. The “a” value considers the states caused by the present event. The “a” value does not include the value of the node under consideration, but includes the value of the nodes above the node under consideration.

In the equation, the value “n”=number of nodes with states affected by other events, i.e., the nodes below the node under consideration. If there is a node below the impacted node that has a state, that state is probably more important to the current node than its own state—if the current node depends on a node that has a state which is “down,” the lower node probably is more important in determining the root cause.

This analysis can input the current state of the dependency graph. As more events come in, the rankings change. Hence, this operates on the fly. As the events come in, the more important events eventually bubble up to the top.

The analysis can perform a single traversal and gather the data for later evaluation, in one pass, and then rank it afterwards. Accordingly, the processing can be very quick and efficient, even for a massive dependency graph.

The “w” value represents a weighting which can be used as desired. For example, w can be used to determine that certain events are always most important. An event that is +1 will be brought to the top. Any conventional technique for weighting can be applied. “w” is optional, not necessary. If there are two events coming from the same system that say the same thing, w can be used to prefer one of the events over the other event. E.g., domain events can be upgraded where they are critical. This can be manually set by a user.

Operationally, a user interface (UI) can be provided to request an analysis pursuant to the present method and system. That is, such a UI can be run by a system administrator on demand.

Any event that caused a change in state can be evaluated. Alternatively, any element listed in the dependency graph can be evaluated. In the UI, for example, events for services are shown (e.g., “web service is down”). Clicking on the “web service” can cause the system to evaluate the web service node. Events occur as usual. The UI can be auto-refreshing. Each one of the events can cause a state change on a node (per the dependency graph). The calculation (for example, (ra/n+1)+w) can be performed for each of the events that come into the system that is being watched. An event that comes in to the dependency graph is associated with a particular node as it arrives, e.g., UPS went down (node and event). There might be multiple events associated with a particular node, when it is evaluated.

The information which the method and system provides ranks the more likely problems, allowing the system administrator to focus on the most likely problems.

This system can provide, e.g., the top 20 events broken down into, e.g., the top four most likely problems.

The present system and method can provide a score, and the score can be used to rank the events.

In an alternative embodiment, the UI can obtain the scores, sort the scores, figure out the score as a percentage of the total scores, and provide this calculation as the “confidence” that this is the root cause of the problem. For example, an event with a confidence score of 80% is most likely the root cause of the system problem, whereas if 50% is the highest confidence ranking a user would want to check all of the 50% confidence events.

The system can store the information gathered during traversal: the state caused by the event (in node state cache 131), the node, and the events themselves (in event cache 133), when the nodes are traversed. Then the algorithm applies the equation to each event to provide a score, the sort of scores in order is prepared, the confidence factor is optionally calculated, and this information can be provided to the user so that the user can more easily make a determination about what is the real problem.

Conceptually this system can work on any dependency graph.

This can be executed on a system that monitors the items listed in the dependency graph. This can be downloaded or installed in accordance with usual techniques, e.g., on a single system. This system can be distributed, but that is not necessary. This can be readily implemented in, e.g., Java or any other appropriate programming language. The information collected can be stored in a conventional graph data base, and/or alternatives thereof.

Consequently, there can be provided:

A system with a dependency graph, e.g., having impacts and events, comprising:
receiving events that cause state changes in the dependency graph;
executing the analyzer that analyzes and ranks individual nodes in the dependency graph based on the states of the nodes which impact the individual node and the states of the nodes which are impacted by the individual node, optionally as (ra/n+1)+w, to provide a score for each of one or more event(s) which are associated with a particular node;
ranking all of the events; and
providing the ranking to the user as indicating the most likely root cause of the event.

Different ways of ranking can be provided.

A dynamic dependency graph may be used.

The Zenoss dependency graph may be used.

A confidence factor may be provided from the ranks

Dependency Graph Discussion

The following discussion provides some background on an exemplary type of dependency graph which can be used in connection with the method and system discussed herein.

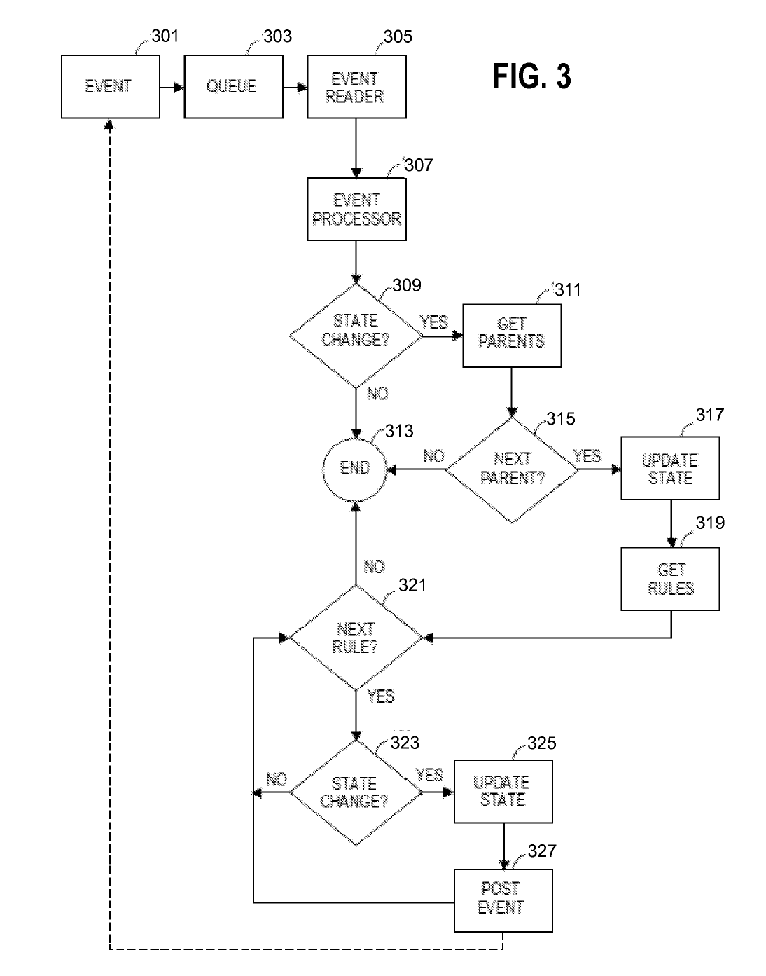

Referring now to FIG. 3, a flow chart illustrating a procedure for event correlation related to service impact analysis will be discussed and described. In FIG. 3, an event 301 is received into a queue 303. The event is associated with an element (see below). An event reader 305 reads each event from the queue, and forwards the event to an event processor. The event processor 307 evaluates the event in connection with the current state of the element on which the event occurred. If the event does not cause a state change 309, then processing ends 313. If the event causes a state change 309, the processor gets the parents 311 of the element. If there is no parent of the element 315, then processing ends 313. However, if there is a parent of the element 315, then the state of the parent element is updated 317 based on the event (state change at the child element), and the rules for the parent element are obtained 319. If there is a rule 321, and when the state changed 323 based on the event, then the state of the parent element is updated 325 and an event is posted 327 (which is received into the event queue). If there is no state change 323, then the system proceeds to obtain any next rule 321 and process that rule also. When the system is finished processing 321 all of the rules associated with the element and its parent(s), then processing ends 313. Furthermore, all of the events (if any) caused by the state change due to the present event are now in the queue 303 to be processed.

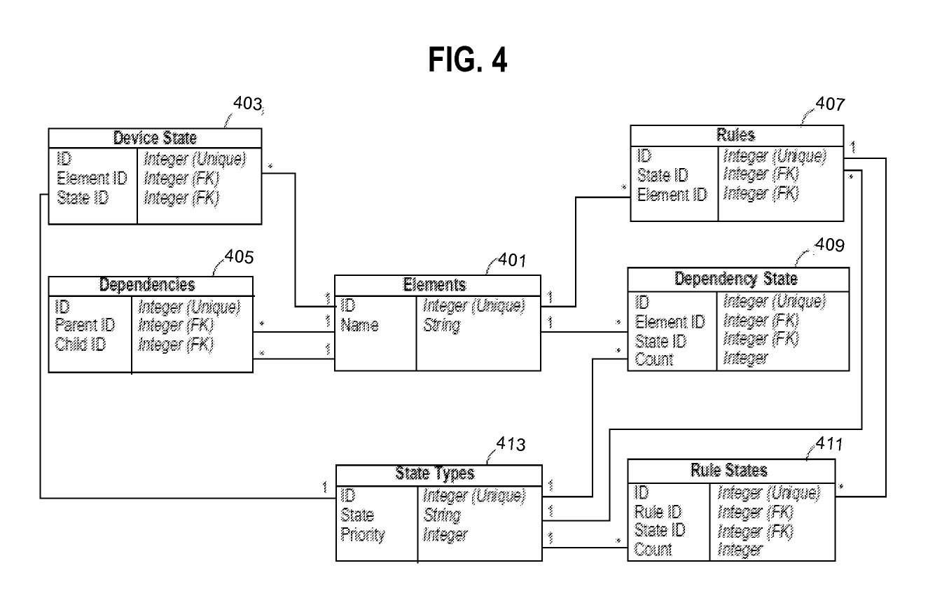

Referring now to FIG. 4, a relational block diagram illustrating a “dependency chain” structure to contain and analyze element and service state will be discussed and described. FIG. 4 illustrates a relational structure that can be used to contain and analyze element and service state. A “dependency chain” is sometimes referred to herein as a dependency tree or a dependency graph.

The Element 401 has a Device State 403, Dependencies 405, Rules 407, and Dependency State 409. The Rules 407 have Rule States 411 and State Types 413. The Dependency State 409 has State Types 413. The Device State 403 has State Types 413.

As illustrated in FIG. 4, the Element 401 in the dependency chain has a unique ID (that is, unique to all other elements) and a name. The Rules 407 have a unique ID (that is, unique to all other rules), a state ID, and an element ID. The Dependency State 409 has a unique ID (that is, unique to all other dependency states), an element ID, a state ID, and a count. The State Type 413 has a unique ID (that is, unique to all other state types), a state (which is a descriptor, e.g., a string), and a priority relative to other states. The Rule States 411 has a unique ID (that is, unique to all other rule states), a rule ID, a state ID, and a count. The Device State 403 has a unique ID (that is, unique to all other device states), an element ID, and a state ID. The Dependencies 405 has a unique ID (that is, unique to all other dependencies), a parent ID, and a child ID.

In the Dependencies 405, the parent ID and the child ID are each a field containing an Element ID for the parent and child, respectively, of the Element 401 in the dependency chain. By using the child ID, the child can be located within the elements and the state of the child can be obtained.

The Device State 403 indicates which of the device states are associated with the Element 401. States can be user-defined. They can include, for example, up, down, and the like.

The Rules 407 indicates the rules which are associated with the Element 401. The rules are evaluated based on the collective state of all of the immediate children of the current element.

The Dependency State 409 indicates which of the dependency states are associated with the Element 401. This includes the aggregate state of all of the element's children.

The Rule States 411 indicates which of the rules states are associated with one of the Rules 2\407.

The State Types 413 table defines the relative priorities of the states. This iterates the available state conditions, and what priority they have against each other. For example, availability states can include “up”, “degraded” “at risk” and “down”; when “down” is a higher priority than “up”, “at risk” or “degraded”, then the aggregate availability state of collective child elements having “up”, “at risk”, “degraded” and “down” is “down.” A separate “compliance” state can be provided, which can be “in compliance” or “out of compliance”. Accordingly, an element can have different types of states which co-exist, e.g., both an availability state and a compliance state.

Consider an example dependency graph representing a network in which there are three physical data centers. Each of the data centers supports a particular service. As impact events occur in each data center, they roll up to the top node which is the reference element, and the state is passed across to the remote instance, and the remote instance has a graph defining a state proxy. As that proxy changes state, that is injected into the remote impact graph and then rolled up in the remote impact graph. An impact event that occurs half way around the world can affect the service at the local data center.

A reference element is a user defined collection of physical, logical, and/or virtual elements. For example, the user can define a collection of infrastructure such as a disaster recovery data center. If a major failure occurs in the reference element, which this collection of infrastructure that constitutes the disaster recovery data center, the user requires to be notified. The way to know that is to tie multiple disparate instances of the system together as a reference element and to have a policy that calls for notifying the user if the reference element has a negative availability event or a negative compliance event.

A virtual element is one of a service, operating system, or virtual machine.

A logical element is a collection of user-defined measures (commonly referred to in the field as a synthetic transaction). For example, a service (such as a known outside service) can make a request and measure the response time. The response time measurement is listed in the graph as a logical element. The measurement can measure quality, availability, and/or any arbitrary parameter that the user considers to be important (e.g., is the light switch on). The logical element can be scripted to measure a part of the system, to yield a measurement result. Other examples of logical elements include configuration parameters, where the applications exist, processes sharing a process, e.g., used for verifying E-Commerce applications, which things are operating in the same processing space, which things are operating in the same networking space, encryption of identifiers, lack of storing of encrypted identifiers, and the like.

A physical element can generate an event in accordance with known techniques, e.g., the physical element (a piece of hardware) went down or is back on-line.

A reference element can generate an event when it has a state change which is measured through an impact analysis.

A virtual element can generate an event in accordance with known techniques, for example, an operating system, application, or virtual machine has defined events which it generates according to conventional techniques.

A logical element can generate an event when it is measured, in accordance with known techniques.

FIG. 4 is an example schema in which all of these relationships can be stored, in a format of a traditional relational database for ease of discussion. In this schema, there might be an element right above the esx6 server, which in this example is a virtual machine cont5-java.zenoss.loc. In the dependency table (FIG. 4), the child ID of the virtual machine cont5-java.zenoss-loc is esx6.zenoss.loc. The event occurs on the element ID for esx6, perhaps causing the esx6 server to be down, then the parents of the element are obtained, and the event is processed for the parents (child is down). The rules associated with the parent IDs can be obtained, the event processed, and it can be determined whether the event causes a state change for the parent. Referring back to FIG. 3, if there is a state change because the child state changed and the rule results in a new state for the immediate parent, this new event is posted and passed to the queue. After that, the new event (a state change for this particular element) is processed and handled as outlined above.

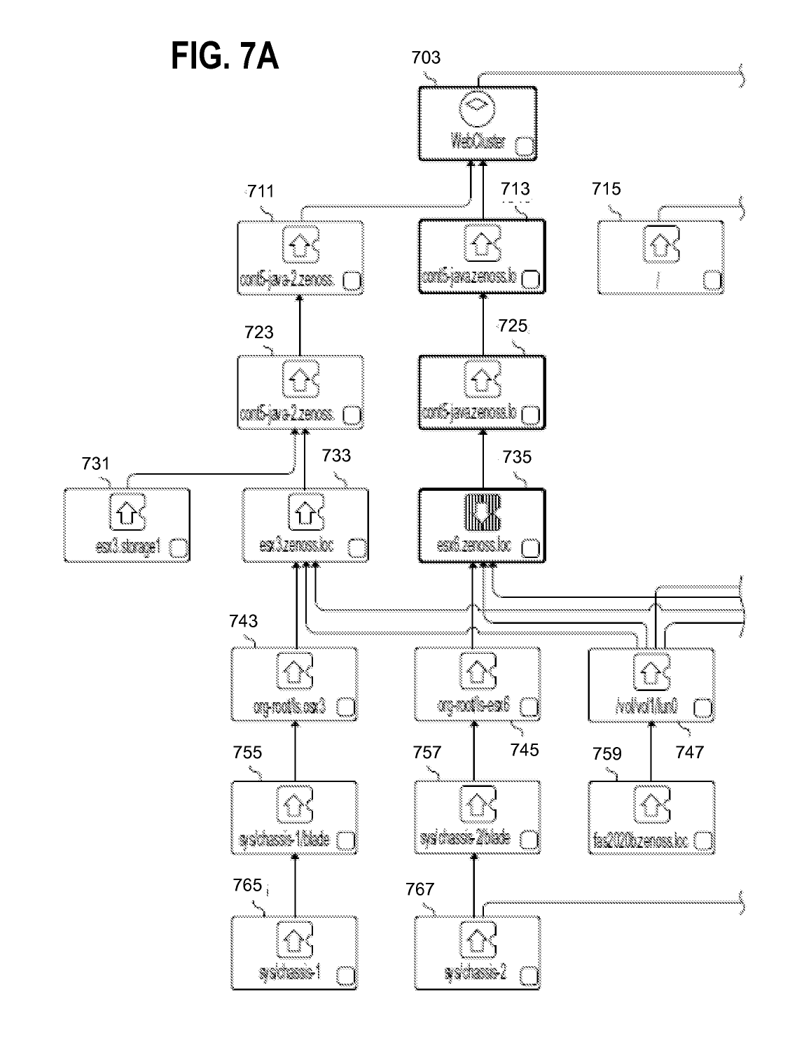

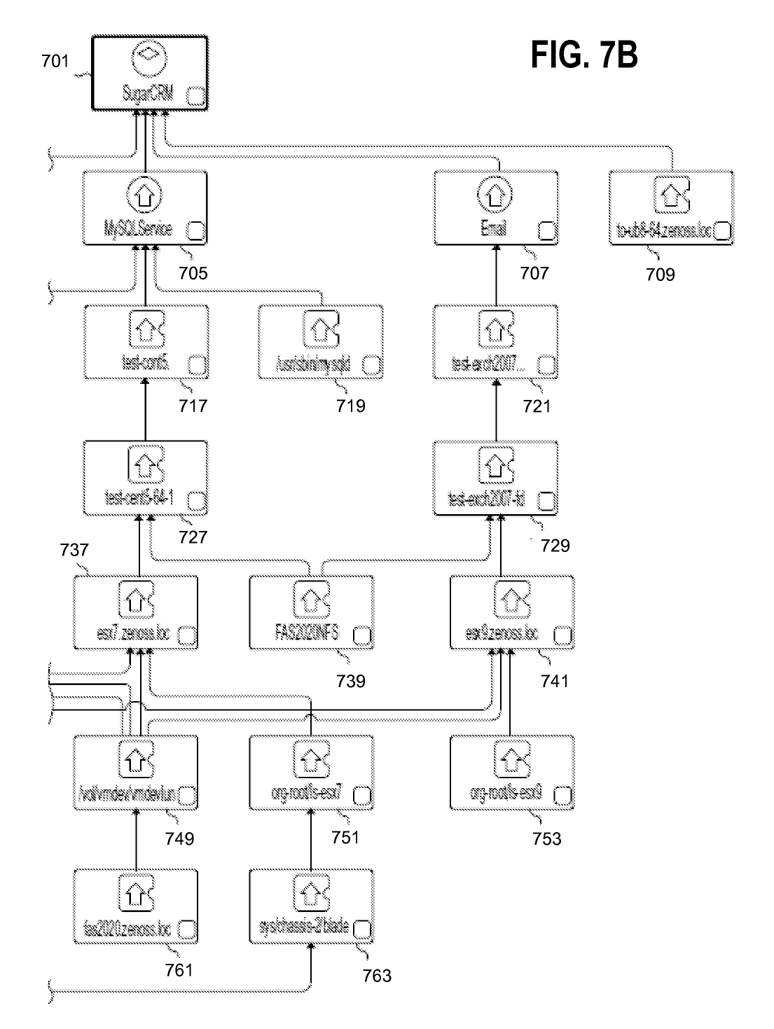

Referring now to FIG. 7A to FIG. 7B, a screen shot of a dependency tree will be discussed and described. The dependency tree is spread over two drawing sheets due to space limitations. Here, an event has occurred at the esx6.zenoss.loc service 735 (with the down arrow). That event rolls up into the virtual machine cont5-java.zenoss.loc 725, i.e., the effect of the event on the parents (possibly up to the top of the tree). That event (server down) is forwarded into the event queue, at which point the element which has a dependency on esx6 (cont5-java.zenoss.loc 725, illustrated above the esx6 server 735) will start to process that event against its policy. Each of the items illustrated here in a rectangle is an element 701-767. The parent/child relationships are stored in the dependency table (see FIG. 4).

In FIG. 7A to FIG. 7B, the server esx6 735 is an element. The server esx6 went down, which is the event for the esx6 element. The event is placed into the queue. The dependencies are pulled up, which are the parents of the esx6 element (i.e., roll-up to the parent), here cont5-java.zenoss.loc 725; the rules for cont5-java.zenossloc are processed with the event; if this is a change that cause an event, the event is posted and passed to the queue e.g., to conl5-java.zenossloc 713; if there is no event caused, then no event is posted and there is no further roll-up.

Computer System

Referring now to FIG. 5 and FIG. 6, a computer of a type suitable for implementing and/or assisting in the implementation of the processes described herein will now be discussed and described. Viewed externally in FIG. 5, a computer system designated by reference numeral 501 has a central processing unit 502 having disk drives 503 and 504. Disk drive indications 503 and 504 are merely symbolic of a number of disk drives which might be accommodated by the computer system. Typically these would include a floppy disk drive such as 503, a hard disk drive (not shown externally) and a CD ROM or digital video disk indicated by slot 504. The number and type of drives varies, typically with different computer configurations. Disk drives 503 and 504 are in fact options, and for space considerations, may be omitted from the computer system used in conjunction with the processes described herein.

The computer can have a display 505 upon which information is displayed. The display is optional for the network of computers used in conjunction with the system described herein. A keyboard 506 and a pointing device 507 such as mouse will be provided as input devices to interface with the central processing unit 502. To increase input efficiency, the keyboard 506 may be supplemented or replaced with a scanner, card reader, or other data input device. The pointing device 507 may be a mouse, touch pad control device, track ball device, or any other type of pointing device.

FIG. 6 illustrates a block diagram of the internal hardware of the computer of FIG. 5. A bus 615 serves as the main information highway interconnecting the other components of the computer 601. CPU 603 is the central processing unit of the system, performing calculations and logic operations required to execute a program. Read only memory (ROM) 619 and random access memory (RAM) 621 may constitute the main memory of the computer 601.

A disk controller 617 can interface one or more disk drives to the system bus 615. These disk drives may be floppy disk drives such as 627, a hard disk drive (not shown) or CD ROM or DVD (digital video disk) drives such as 625, internal or external hard drives 629, and/or removable memory such as a USB flash memory drive. These various disk drives and disk controllers may be omitted from the computer system used in conjunction with the processes described herein.

A display interface 611 permits information from the bus 615 to be displayed on the display 609. A display 609 is also an optional accessory for the network of computers. Communication with other devices can occur utilizing communication port 1423 and/or a combination of infrared received 631 and infrared transmitter 633.

In addition to the standard components of the computer, the computer can include an interface 613 which allows for data input through the keyboard 605 or pointing device such as a mouse 607, touch pad, track ball device, or the like.

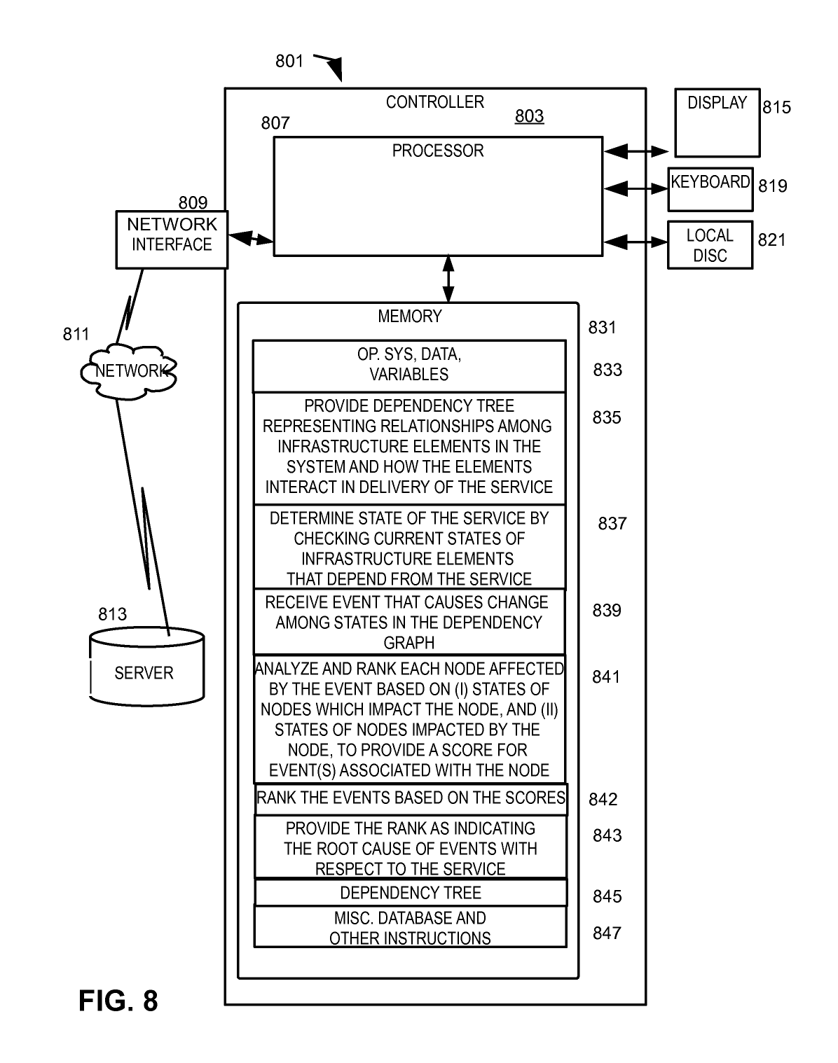

Referring now to FIG. 8, a block diagram illustration portions of a computer system will be discussed and described. A computer system may include a computer 801, a network 811, and one or more remote device and/or computers, here represented by a server 813. The computer 801 may include one or more controllers 803, one or more network interfaces 809 for communication with the network 811 and/or one or more device interfaces (not shown) for communication with external devices such as represented by local disc 821. The controller may include a processor 807, a memory 831, a display 815, and/or a user input device such as a keyboard 819. Many elements are well understood by those of skill in the art and accordingly are omitted from this description.

The processor 807 may comprise one or more microprocessors and/or one or more digital signal processors. The memory 831 may be coupled to the processor 807 and may comprise a read-only memory (ROM), a random-access memory (RAM), a programmable ROM (PROM), and/or an electrically erasable read-only memory (EEPROM). The memory 831 may include multiple memory locations for storing, among other things, an operating system, data and variables 833 for programs executed by the processor 807; computer programs for causing the processor to operate in connection with various functions; a database in which the dependency tree 845 and related information is stored; and a database 847 for other information used by the processor 807. The computer programs may be stored, for example, in ROM or PROM and may direct the processor 807 in controlling the operation of the computer 801.

Programs that are stored to cause the processor 807 to operate in various functions such as to provide 835 a dependency tree representing relationships among infrastructure elements in the system and how the elements interact in delivery of the service; to determine 837 the state of the service by checking current states of infrastructure elements that depend from the service; [LIST]. These functions are described herein elsewhere in detail and will not be repeated here.

The user may invoke functions accessible through the user input device, e.g., a keyboard 819, a keypad, a computer mouse, a touchpad, a touch screen, a trackball, or the like.

Automatically upon receipt of an event from a physical device (such as local disc 821 or server 813), or automatically upon receipt of certain information via the network interface 809, the processor 807 may process the infrastructure event as defined by the dependency tree 845.

The display 815 may present information to the user by way of a conventional liquid crystal display (LCD) or other visual display, and/or by way of a conventional audible device (e.g., a speaker) for playing out audible messages. Further, notifications may be sent to a user in accordance with known techniques, such as over the network 811 or by way of the display 815.

The detailed descriptions which appear above may be presented in terms of program procedures executed on a computer or network of computers. These procedural descriptions and representations herein are the means used by those skilled in the art to most effectively convey the substance of their work to others skilled in the art.

Further, this invention has been discussed in certain examples as if it is made available by a provider to a single customer with a single site. The invention may be used by numerous customers, if preferred. Also, the invention may be utilized by customers with multiple sites and/or agents and/or licensee-type arrangements.

The system used in connection with the invention may rely on the integration of various components including, as appropriate and/or if desired, hardware and software servers, applications software, database engines, server area networks, firewall and SSL security, production back-up systems, and/or applications interface software.

A procedure is generally conceived to be a self-consistent sequence of steps leading to a desired result. These steps are those requiring physical manipulations of physical quantities. Usually, though not necessarily, these quantities take the form of electrical or magnetic signals capable of being stored on non-transitory computer-readable media, transferred, combined, compared and otherwise manipulated. It proves convenient at times, principally for reasons of common usage, to refer to these signals as bits, values, elements, symbols, characters, terms, numbers, or the like. It should be noted, however, that all of these and similar terms are to be associated with the appropriate physical quantities and are merely convenient labels applied to these quantities.

Further, the manipulations performed are often referred to in terms such as adding or comparing, which are commonly associated with mental operations performed by a human operator. While the present invention contemplates the use of an operator to access the invention, a human operator is not necessary, or desirable in most cases, to perform the actual functions described herein; the operations are machine operations.

Various computers or computer systems may be programmed with programs written in accordance with the teachings herein, or it may prove more convenient to construct a more specialized apparatus to perform the required method steps. The required structure for a variety of these machines will appear from the description given herein.

It should be noted that the term “computer system” or “computer” used herein denotes a device sometimes referred to as a computer, laptop, personal computer, personal digital assistant, personal assignment pad, server, client, mainframe computer, or equivalents thereof provided such unit is arranged and constructed for operation with a data center.

Furthermore, the communication networks of interest include those that transmit information in packets, for example, those known as packet switching networks that transmit data in the form of packets, where messages can be divided into packets before transmission, the packets are transmitted, and the packets are routed over network infrastructure devices to a destination where the packets are recompiled into the message. Such networks include, by way of example, the Internet, intranets, local area networks (LAN), wireless LANs (WLAN), wide area networks (WAN), and others. Protocols supporting communication networks that utilize packets include one or more of various networking protocols, such as TCP/IP (Transmission Control Protocol/Internet Protocol), Ethernet, X.25, Frame Relay, ATM (Asynchronous Transfer Mode), IEEE 802.11, UDP/UP (Universal Datagram Protocol/Universal Protocol), IPX/SPX (Inter-Packet Exchange/Sequential Packet Exchange), Net BIOS (Network Basic Input Output System), GPRS (general packet radio service), I-mode and other wireless application protocols, and/or other protocol structures, and variants and evolutions thereof. Such networks can provide wireless communications capability and/or utilize wireline connections such as cable and/or a connector, or similar.

The term “data center” is intended to include definitions such as provided by the Telecommunications Industry Association as defined for example, in ANSI/TIA-942 and variations and amendments thereto, the German Datacenter Star Audi Programme as revised from time-to-time, the Uptime Institute, and the like.

It should be noted that the term infrastructure device or network infrastructure device denotes a device or software that receives packets from a communication network, determines a next network point to which the packets should be forwarded toward their destinations, and then forwards the packets on the communication network. Examples of network infrastructure devices include devices and/or software which are sometimes referred to as servers, clients, routers, edge routers, switches, bridges, brouters, gateways, media gateways, centralized media gateways, session border controllers, trunk gateways, call servers, and the like, and variants or evolutions thereof.

This disclosure is intended to explain how to fashion and use various embodiments in accordance with the invention rather than to limit the true, intended, and fair scope and spirit thereof. The invention is defined solely by the appended claims, as they may be amended during the pendency of this application for patent, and all equivalents thereof. The foregoing description is not intended to be exhaustive or to limit the invention to the precise form disclosed. Modifications or variations are possible in light of the above teachings. The embodiment(s) was chosen and described to provide the best illustration of the principles of the invention and its practical application, and to enable one of ordinary skill in the art to utilize the invention in various embodiments and with various modifications as are suited to the particular use contemplated. All such modifications and variations are within the scope of the invention as determined by the appended claims, as may be amended during the pendency of this application for patent, and all equivalents thereof, when interpreted in accordance with the breadth to which they are fairly, legally, and equitably entitled.

What is claimed is:

1. A computer-implemented system that determines a root cause of a service impact, comprising:
a dependency graph data storage configured to store a dependency graph that includes nodes which represent states of infrastructure elements in a managed system, and impacts and events among the infrastructure elements in a managed system that are related to delivery of a service by the managed system; and
a processor that is configured to
receive events that can cause change among the states in the dependency graph, wherein an event occurs in relation to one of the infrastructure elements in a managed system;
for each of the events, execute an analyzer that analyzes and ranks each individual node in the dependency graph that was affected by the event based on (i) states of the nodes which impact the individual node, and (ii) the states of the nodes which are impacted by the individual node, to provide a score for each of at least one event which is associated with the individual node;
rank all of the events based on the scores; and
provide the rank as indicating a root cause of the events with respect to the service.

2. The computer-implemented system of claim 1, wherein the dependency graph represents relationships among all infrastructure elements in the managed system that are related to delivery of the service by the managed system, and how the infrastructure elements interact with each other in a delivery of said service, and a state of an infrastructure element is impacted only by states among its immediately dependent infrastructure elements of the dependency tree; and
the processor is configured to determines the state of the service by checking current states of infrastructure elements in the dependency tree that immediately depend from the service.

3. The computer-implemented system of claim 1, wherein the individual node in the dependency graph is ranked consistent with the formula (ra/n+1)+w, to provide the score for each of the at least one event which is associated with the individual node, wherein:
r=an integer value of the state caused by the at least one event;
a=an average of the integer values of the states of nodes impacted, directly or indirectly, by the node affected by the at least one event;
n=number of nodes with states affected by other events impacting the node affected by the at least one event; and
w=an optional adjustment that can be provided to influence the score for the at least one event.

4. The computer-implemented system of claim 1, wherein
states indicated for the infrastructure element include availability states of at least: up, down, at risk, and degraded,
“up” indicates a normally functional state, “down” indicates a non-functional state, “at risk” indicates a state at risk for being “down”, and “degraded” indicates a state which is available and not fully functional.

5. The computer-implemented system of claim 1, wherein
states indicated for the infrastructure element include performance states of at least up, degraded, and down,
“up” indicates a normally functional state, “down” indicates a non-functional state, and “degraded” indicates a state which is available and not fully functional.

6. The computer-implemented system of claim 1, wherein the infrastructure elements include:
the service;
a physical element that generates an event caused by a pre-defined physical change in the physical element;
a logical element that generates an event when it has a pre-defined characteristic as measured through a synthetic transaction;
a virtual element that generates an event when a predefined condition occurs; and
a reference element that is a pre-defined collection of other different elements among the same dependency tree, for which a single policy is defined for handling an event that occurs within the reference element.

7. The computer-implemented system of claim 1, wherein
the processor determines the state of the infrastructure element according an absolute calculation specified in a policy assigned to the infrastructure element.

8. A computer-implemented method that determines a root cause of a service impact, comprising:
storing, in a dependency graph data storage that stores a dependency graph that includes nodes which represent states of infrastructure elements in a managed system, and impacts and events among the infrastructure elements in a managed system that are related to delivery of a service by the managed system;
receiving, in a processor, events that can cause change among the states in the dependency graph, wherein an event occurs in relation to one of the infrastructure elements in a managed system;
for each of the events, executing, in the processor, an analyzer that analyzes and ranks each individual node in the dependency graph that was affected by the event based on (i) states of the nodes which impact the individual node, and (ii) the states of the nodes which are impacted by the individual node, to provide a score for each of at least one event which is associated with the individual node;
ranking, in the processor, all of the events based on the scores; and
providing, in the processor, the rank as indicating a root cause of the events with respect to the service.

9. The method of claim 8, wherein the dependency graph represents relationships among all infrastructure elements in the managed system that are related to delivery of the service by the managed system, and how the infrastructure elements interact with each other in a delivery of said service, and a state of an infrastructure element is impacted only by states among its immediately dependent infrastructure elements of the dependency tree; and further comprising
determining, in the processor, the state of the service by checking current states of infrastructure elements in the dependency tree that immediately depend from the service.

10. The method of claim 8, wherein the individual node in the dependency graph is ranked consistent with the formula (ra/n+1)+w, to provide the score for each of the at least one event which is associated with the individual node, wherein:
r=an integer value of the state caused by the at least one event;
a=an average of the integer values of the states of nodes impacted, directly or indirectly, by the node affected by the at least one event;
n=number of nodes with states affected by other events impacting the node affected by the at least one event; and
w=an optional adjustment that can be provided to influence the score for the at least one event.

11. The method of claim 8, wherein
states indicated for the infrastructure element include availability states of at least: up, down, at risk, and degraded,
“up” indicates a normally functional state, “down” indicates a non-functional state, “at risk” indicates a state at risk for being “down”, and “degraded” indicates a state which is available and not fully functional.

12. The method of claim 8, wherein
states indicated for the infrastructure element include performance states of at least up, degraded, and down,
“up” indicates a normally functional state, “down” indicates a non-functional state, and “degraded” indicates a state which is available and not fully functional.

13. The method of claim 8, wherein the infrastructure elements include:
the service;
a physical element that generates an event caused by a pre-defined physical change in the physical element;
a logical element that generates an event when it has a pre-defined characteristic as measured through a synthetic transaction;
a virtual element that generates an event when a predefined condition occurs; and
a reference element that is a pre-defined collection of other different elements among the same dependency tree, for which a single policy is defined for handling an event that occurs within the reference element.

14. The method of claim 8, further comprising determining, in the processor, the state of the infrastructure element according an absolute calculation specified in a policy assigned to the infrastructure element.

15. A non-transitory computer-readable medium comprising instructions being executed by a computer, the instructions including a computer-implemented method that determines a root cause of a service impact, the instructions implement:
storing, in a dependency graph data storage that stores a dependency graph that includes nodes which represent states of infrastructure elements in a managed system, and impacts and events among the infrastructure elements in a managed system that are related to delivery of a service by the managed system;
receiving events that can cause change among the states in the dependency graph, wherein an event occurs in relation to one of the infrastructure elements in a managed system;
for each of the events, executing an analyzer that analyzes and ranks each individual node in the dependency graph that was affected by the event based on (i) states of the nodes which impact the individual node, and (ii) the states of the nodes which are impacted by the individual node, to provide a score for each of at least one event which is associated with the individual node;
ranking all of the events based on the scores; and
providing the rank as indicating a root cause of the events with respect to the service.

16. The non-transitory computer-readable medium of claim 15, wherein the dependency graph represents relationships among all infrastructure elements in the managed system that are related to delivery of the service by the managed system, and how the infrastructure elements interact with each other in a delivery of said service, and a state of an infrastructure element is impacted only by states among its immediately dependent infrastructure elements of the dependency tree; and further comprising
determining the state of the service by checking current states of infrastructure elements in the dependency tree that immediately depend from the service.

17. The non-transitory computer-readable medium of claim 15, wherein the individual node in the dependency graph is ranked consistent with the formula (ra/n+1)+w, to provide the score for each of the at least one event which is associated with the individual node, wherein:
r=an integer value of the state caused by the at least one event;
a=an average of the integer values of the states of nodes impacted, directly or indirectly, by the node affected by the at least one event;
n=number of nodes with states affected by other events impacting the node affected by the at least one event; and
w=an optional adjustment that can be provided to influence the score for the at least one event.

18. The non-transitory computer-readable medium of claim 15, wherein
states indicated for the infrastructure element include availability states of at least: up, down, at risk, and degraded,
“up” indicates a normally functional state, “down” indicates a non-functional state, “at risk” indicates a state at risk for being “down”, and “degraded” indicates a state which is available and not fully functional.

19. The non-transitory computer-readable medium of claim 15, wherein
states indicated for the infrastructure element include performance states of at least up, degraded, and down,
“up” indicates a normally functional state, “down” indicates a non-functional state, and “degraded” indicates a state which is available and not fully functional.

20. The non-transitory computer-readable medium of claim 15, wherein the infrastructure elements include:
the service;
a physical element that generates an event caused by a pre-defined physical change in the physical element;
a logical element that generates an event when it has a pre-defined characteristic as measured through a synthetic transaction;
a virtual element that generates an event when a predefined condition occurs; and
a reference element that is a pre-defined collection of other different elements among the same dependency tree, for which a single policy is defined for handling an event that occurs within the reference element.

21. The non-transitory computer-readable medium of claim 15, further comprising determining the state of the infrastructure element according an absolute calculation specified in a policy assigned to the infrastructure element.
